(19) United States
(12) Patent Application Publication
(10) Pub. No.: US 2011/0183725 A1
(43) Pub. Date: Jul. 28, 2011

(54) Hands-Free Text Messaging

(76) Inventors: Shai Cohen, Ra'anana (IL); Eli Malyanker, Hod-Hasharon (IL)

(21) Appl. No.: 12/695,300

(22) Filed: Jan. 28, 2010

(51) Int. Cl. G10L 21/06; G06F 3/02; H04W 88/02; G10L 13/08

(52) U.S. Cl. 455/569.1; 345/169; 704/235; 704/260

(57) ABSTRACT

A personal digital assistant (PDA) system that comprises a housing including: a housing transceiver configured to wirelessly transmit a text message to a PDA; a voice recognition module (VRM) connected to the housing transceiver and configured to convert an auditory message from a user into a text message; a Text to speech module (TTM) configured to convert test into speech; and a microphone connected to the VRM and configured to receive an auditory message from the user. The system additionally includes a PDA located a distance from the housing, the PDA being configured to wirelessly receive a text message from the housing transceiver and transmit the text message to a recipient via a public switched telephone network (PSTN), such that the PDA is operable in a hands-free mode by the user.

### BACKGROUND

1. Technical Field

The invention relates generally to personal digital assistant (PDA) assemblies, and more particularly to PDA assemblies including hands-free PDA text messaging.

2. Discussion of Related Art

Text messages, more commonly referred to as short message service (SMS) messages, are known in the art of telecommunications. While generally useful for their purpose, it can at times be slow for a user to type out SMS messages with their mobile station (PDA), for example a wireless mobile telephone.

Additionally, typing SMS messages during operation of a vehicle is illegal and extremely dangerous as the sender diverts attention to the PDA, away from road conditions; a diversion that may result in a traffic accident and highway deaths.

### BRIEF SUMMARY

Embodiments of the present invention provide a PDA system.

One system comprises a housing including: a housing transceiver configured to wirelessly transmit a text message to a PDA; a voice recognition module (VRM) connected to the housing transceiver and configured to convert an auditory message from a user into a text message; a microphone connected to the VRM and configured to receive an auditory message from the user; and a text to speech module (TTS) in operative association with the PDA, being configured to convert a message in text format into an auditory message.

Accordingly, according to an aspect of the present invention, the system further includes a PDA located in a distance from the housing, the PDA being configured to wirelessly receive a text message from the housing transceiver and transmit the text message to a recipient via a public switched telephone network (PSTN), such that the PDA is operable in a hands-free mode by the user.

According to some embodiments of the invention, the microphone is a part of the housing.

According to some embodiments of the invention, the microphone is located remotely from the housing and wirelessly connected to the VRM.

According to some embodiments, invention includes a speaker connected to the TTS, wherein: the PDA is configured to wirelessly receive a text message from the PSTN and transmit the message to the housing transceiver; the housing transceiver is configured to transmit the text message to the TTS; and the TTS is configured to convert the text message into an auditory message which is broadcast to the user via the speaker.

According to some embodiments of the invention, the speaker is a part of the housing.

According to some embodiments of the invention, the speaker is located remotely from the housing and is wirelessly connected to the TTS.

According to some embodiments, invention includes a cradle, possibly embedded within the steering wheel of a vehicle, configured to receive the PDA, the cradle including an input/output (I/O) interface configured to control the PDA, and the VRM is configured to convert verbal commands into digital commands that are transmitted to the I/O interface to control the PDA operation. Advantageously, the aforementioned configuration provides better ergonomics to the user, by embedding it's functionalities within the vehicle, possibly into the steering wheel.

According to some embodiments, invention includes a memory configured for storing telephonic communication information on at least one recipient.

According to some embodiments of the invention, the memory is configured to respond to at least one command verbally stated by the user and converted into at least one digital command by the VRM.

According to some embodiments of the invention, the housing may be configured for mounting on a steering wheel of an automobile or alternatively, as noted above, by embedding it into a specified location, dedicatedly designed for the housing.

According to some embodiments of the invention, the housing includes at least one control switch that signals at least one signal of readiness of the user to transmit an auditory message.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 shows a schematic view of a mobile communication system, according to some embodiments of the invention;

FIGS. 2-3 show embodiments of the mobile communication system shown in FIG. 1, according to some embodiments of the invention; and

FIG. 4 shows a high level flowchart according to some embodiments of the invention.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention of a hands-free PDA text messaging system enables a user to hear and respond verbally to an SMS message that was sent to a PDA while driving a motor vehicle.

As used herein, PDA refers to any palmtop computing device, optionally with a screen, that may be a color screen and/or a touch screen. The term PDA includes, inter alia, portable personal computers, cell phones; optionally can access Internet, intranets or extranets via Wi-Fi, Wireless Wide Area Networks WWANs; such cell phones being referred to as Smartphones. Cell phones that currently incorporate Smartphone technology include, for example, the Blackberry, Apple iPhone, and the Nokia N-Series.

The user responds to the SMS that he receives directly to the sender either vocally or through SMS texting. A command to record a verbal message, and directions regarding to whom the message should be sent, are optionally initiated verbally, or through input buttons on the system. The above-noted commands and directions, in addition to the actual message, occur through a VRM that is included in the system.

Following receiving a message, the user has the ability to identify the sender of the message, and send an SMS in return, or to communicate verbally with the sender.

In embodiments, the user has the option to send an SMS to any, or all, the listed addressees that are contained in the PDA directory or alternatively the list may be stored on any of the elements of the invention. Such might be the case when the user receives a message that suggests inviting friends to a scheduled get together.

In embodiments, the invention further comprises a video camera that may be in operative association with the other elements of the invention. In operation, the video camera may be used to capture video sequences of the user. Embodiments of the invention may in turn, convert the video sequences into MMS messages transmittable over the communication network by the user.

In embodiments, the main system of the invention is configured to be attached to the steering wheel and may have two functional keys: a first key to control the speech output through a speaker, and a second key to control speech through a microphone. System readiness may be indicated by a dedicated audio or visual indicator, or alternatively, by third key to signal readiness to receive a message. The hands-free PDA text messaging system may be activated utilizing speech commands, or while pressing on any one of the keys located on the steering wheel housing.

As used herein, the phrase “hands-free PDA text messaging system” refers to a PDA which is operated without the hands of a user engaging the PDA, such that PDA function is controlled from a distance from the PDA, either by engaging control inputs, for example buttons on a control box, and/or verbal commands verbalized by a user.

Optionally, when the user receives an SMS message during operation of the vehicle, the device allows a speech-only program to be utilized to command the hands-free PDA text messaging system to perform certain functions. Other functions may be, but are not limited to: initiating a phone call, finding a destination and instruction for arrival to the specified destination.

Additionally, the system enables recording of an SMS and/or an MMS message reply and searching for the recipient name utilizing speech commands, including saying the name of the person to whom a message should be send or additionally, any destination by saying its phone number.

In embodiments, the user executes a search for the specific person, via voice-recognition or by assigning the stated letters to specified names which allows to search for a specific person through three buttons; the user scrolls through the letters displayed on the PDA and, using the buttons on a remote control, picks the letter which is the first letter of the name of the identified person. In this embodiment, the embodiments of the invention repeat in speech, the first letter of the searched name, throughout the name search process.

Alternatively, the user issues verbal commands to the PDA which accesses a memory chip (that may be within the PDA or an element of the invention) that contains the user telephone directory. The user verbally calls out the name of a recipient. The name is then stated via the VRM technology, and the user confirms that the name of the recipient is correct, by pressing, for example, a specified “continue” button.

In the event that there are multiple names with the same first three letters, the system verbalizes the multiple names, each with a number preceding the name. For example:
“1. Joseph Smith
“2. Michael Smith”

In alternative embodiments, the user may request multiple names based on specific parameters that have been entered into the cell phone directory; for example, “all people residing in Manhattan”, “all people who are below the age of 23”, or any other parameter that has been entered into the directory.

Other features of the hands-free PDA text messaging system include allowing the user, while driving, to send items such as photographs and music files through Multimedia Messaging Service (MMS).

In embodiments, much of the digital code for the system is written in the Visual Basic programming language. Additionally, the system may interact with a cellular phone in the vehicle utilizing Bluetooth, infrared, RFID, or any other short-range wireless communication system.

In embodiments, the PDA transmits the message input by the user and/or multimedia files optionally utilizing Global System for Mobile communications (GSM) or General Packet radio service (GPRS).

The user may listen to the SMS messages he receives via the invention and the program, either through the speaker on the housing of the hands-free PDA text messaging system or with a separate speaker that is mounted anywhere in the vehicle, for example near the windshield.

The inventors have discovered that the hands-free PDA text messaging system is not limited to the configurations described below and, in fact, may be configured for a variety of different environments.

In embodiments, a variety of portable models can be configured for bikers, joggers, mountain climbers, soldiers on guard duty, operators of heavy equipment or delicate machinery, even surgeons, etc. Such embodiments allow a user to utilize SMS and MMS without taking their attention away from whatever important functions they may be performing.

In addition, the inventors envision a desktop model designed for the blind, which allows the blind person to hear and send SMS messages in conjunction with a standard PDA.

The drawings are now discussed,

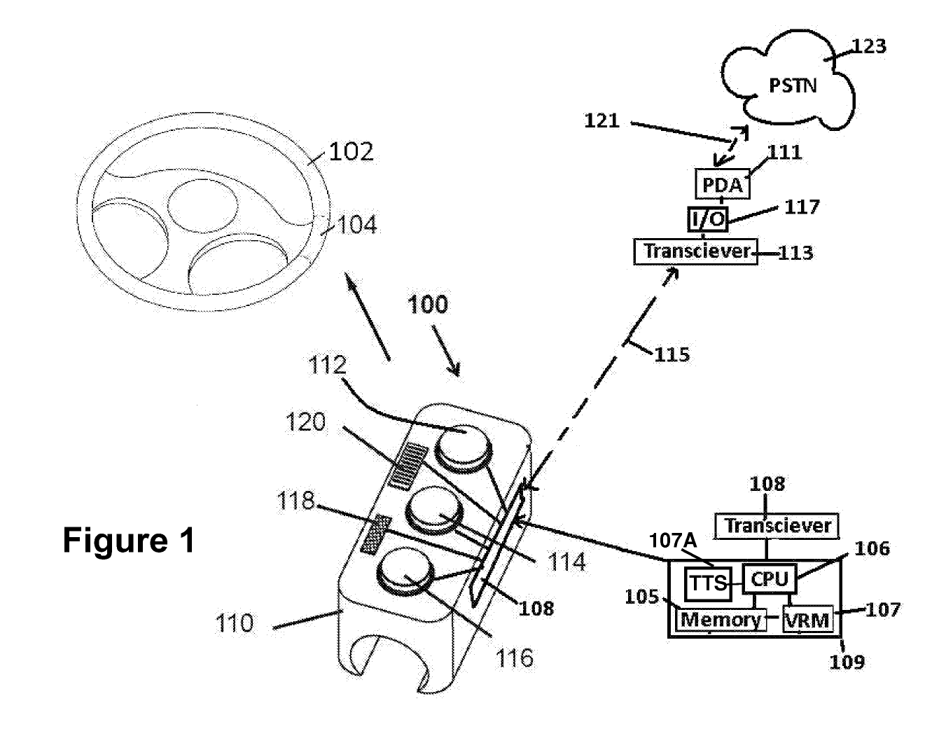

FIG. 1 shows a schematic view of a mobile communication system 100 which mounts on a steering wheel 102 for example in an area 104. Mobile communication system 100 includes a steering wheel housing 110 which includes a speaker 120 and a microphone 118. In embodiments a PDA 111 receives a signal 121 from a public switched telephone network (PSTN) 123 in the usual manner. PDA 111 states, via a speaker, that a new message has arrived in addition to the identity of the sender. The PDA then asks the user whether to play the message.

The user presses a button 112 to answer the PDA and if the message is an oral message a transceiver 113 transmits to a transceiver 108 via Bluetooth, radio frequency, or infrared wireless communication, or any other wireless communication methods that are known or will be developed in the art.

In the event that the PDA receiving an SMS message transceiver 113 again transmits the SMS message to transceiver 108 and a CPU 106, located on a bus 109, transfers the text message to a text to speech module (TTS) 107A. TTS 107A then converts the SMS message into an oral message and CPU 106 directs housing 110 to produce an audiovisual signal.

The user is prompted as to when to activate audio play of the message via speaker 120. When the user is ready to hear the audio transmission the user may press a speaker button 114 (or by speech operated switch) and the oral message is played back.

Should the user wish to send an SMS message, the user may press a microphone button 116 (or by speech operated switch) so that microphone 118 is prepared to receive verbal instructions and messages.

Typically, the user will issue a standard command such as “transform this message into SMS text”. Mobile communication system 100 will provide audiovisual signal that the user may begin speaking. Such an audiovisual signal that comprises lighting up of microphone button 116 and/or an audio signal through speaker 120, to begin speaking.

When the user begins speaking audio signals are transferred through speaker 120 to CPU 106 which sends a message through a voice recognition module (VRM) 107 which then transfers the digital recording of the text message to transceiver 108. Transceiver 108 transfers via a wireless communication 115 to transceiver 113. Transceiver 113 communicates with an input/output (I/O) interface 117 which controls operation of, and passes messages onto PDA 111. PDA 111 will then transmit the message to PSTN 123 and conveys it on to the recipient or recipients. Is should be noted that either of Transceiver 113 and input/output (I/O) interface 117, or both of them may be embedded within PDA 111 .

In embodiments, following the completion of the SMS message, the user will press microphone button 116 and the user will be prompted to specify where to send the SMS message.

If the recipient is the person who sent the message and the user is replying to this message, the user optionally will say a command such as “send reply to initiator”.

If the user wishes to specify a different user, the user will issue a command for example: “search memory”. Mobile communication system 100 then activates a memory unit 105 which stores names and connection information for a variety of individuals stored by the user. In embodiments, mobile communication system 100 will then query the user for the name of the recipient and then will state the name of a person to whom the user wishes to send the message. The user will then be prompted as to whether the name is correct, and the usual reply is “yes”. The user will then issue a verbal command, for example “send a message” or alternatively, via the buttons. Transceiver 108 will then transfer the message wirelessly 115 to transceiver 113 which will then pass the message through I/O so that PDA 111 sends the message through a wireless link 121 to public switched telephone network (PSTN) 123.

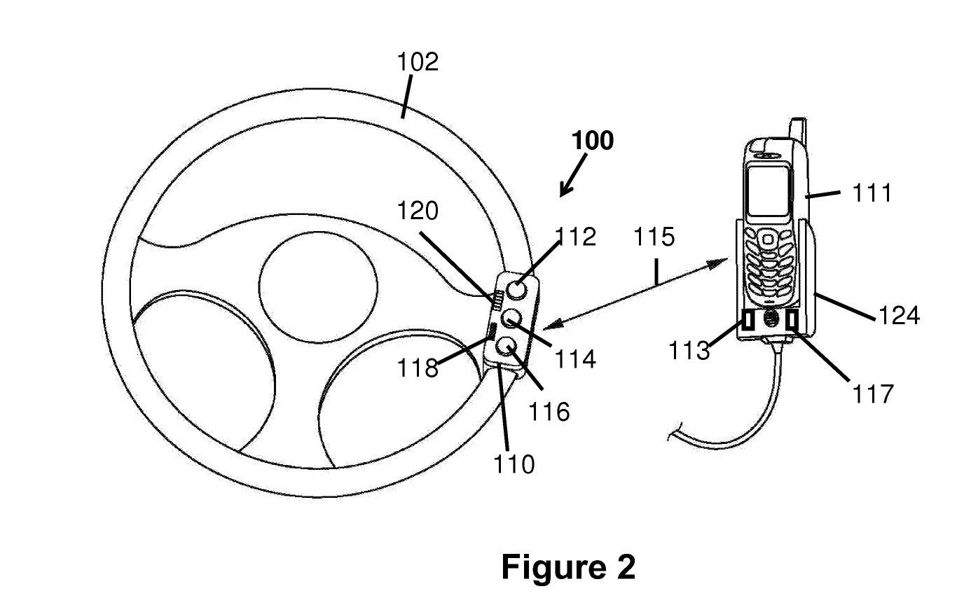

FIG. 2 shows mobile communication system 100 including housing 110 mounted on steering wheel 102 communicating with PDA 111.

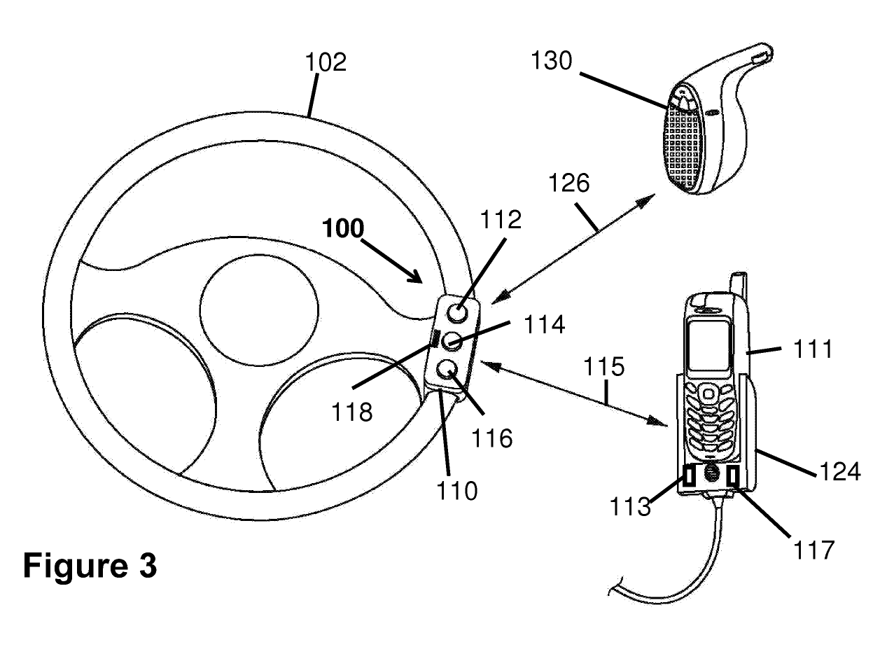

FIG. 3 shows an alternative embodiment in which housing 110 only contains a microphone 118 and communicates with a wireless impulse to an external speaker 130 which provides the user with audible sounds that were provided by speaker 120 mounted on housing 110 (FIG. 2). Alternatively, both microphone 118 and speaker 120 reside within external speaker 130.

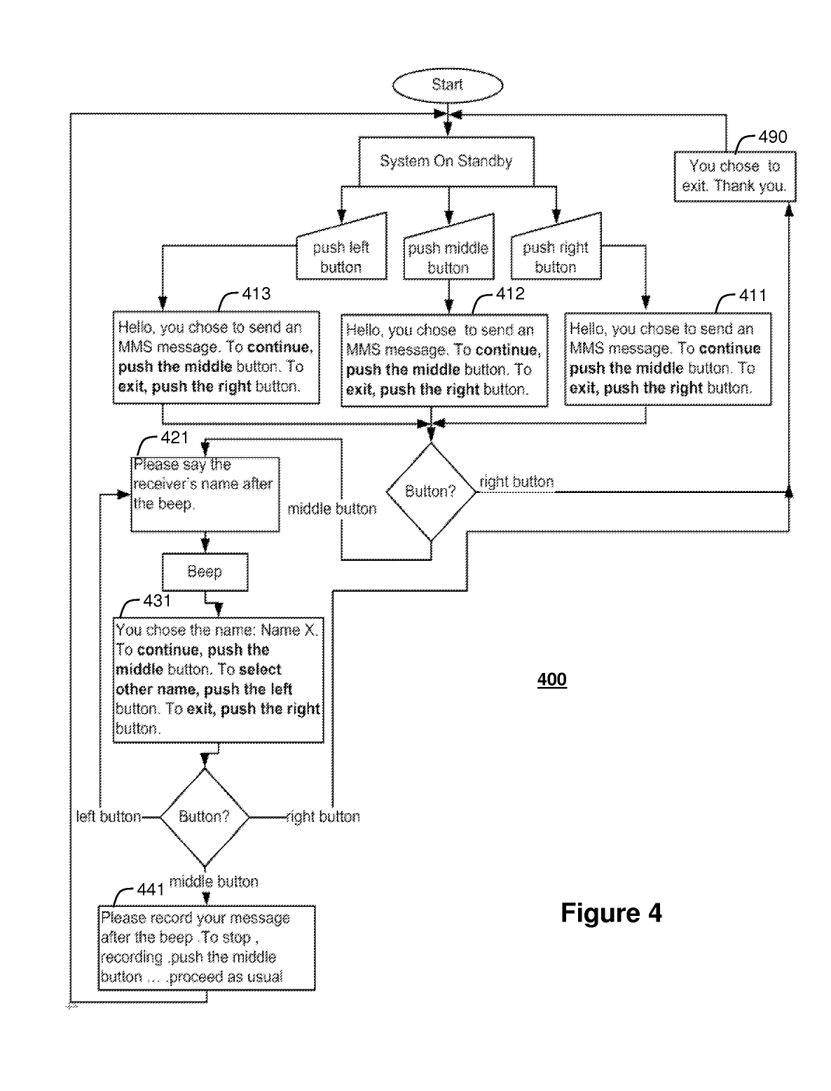

FIG. 4 shows a flowchart of an exemplary, non limiting control flowchart of a voice user interface according to some embodiments of the present invention. The flow 400 illustrates several vocal interfaces available in accordance with the selection of the user. For example, upon start-up of the system any one of the buttons presses (left, middle or right) a welcoming message may be played back, instructing the user of the physical interface (buttons) and the respective functionalities 411-413.

Depending on the pressed button, the user is prompted to state the name of the recipient 421 or exit the system 490. In case a name is stated, a beep is played and the name is selected is played back for confirmation 431. Unless the system is again exited by the user in 490, the user is prompted to record the message in 441 and then the system proceeds to relay the message for transfer as explained above with regards to FIGS. 1-3.

In the above description, an embodiment is an example or implementation of the inventions. The various appearances of “one embodiment”, “an embodiment”, or “some embodiments”, do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment”, or “other embodiments”, means that a particular feature, structure, or characteristic described in connection with the embodiments is included in at least some embodiments, but not necessarily all embodiments, of the inventions.

It is to be understood that the phraseology and terminology employed herein are not to be construed as limiting, and are for descriptive purposes only.

The principles and uses of the teachings of the present invention may be better understood with reference to the accompanying description, Figures, and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting”, and grammatical variants thereof do not preclude the addition of one or more components, features, steps, or integers; or groups thereof, and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques, and procedures by practitioners of the art to which the invention belongs.

The descriptions, examples, methods, and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A personal digital assistant (PDA) system comprising:
a housing including:
a housing transceiver configured to wirelessly transmit a text message to a PDA;
a voice recognition module (VRM) connected to the housing transceiver and configured to convert an auditory message from a user into a text message;
a text to speech module (TTM) connected to the housing transceiver and configured to convert a text into a an auditory message;
a microphone connected to the VRM and configured to receive an auditory message from the user; and
a PDA located a distance from the housing, the PDA being configured to wirelessly receive a text message from the housing transceiver and transmit the text message to a recipient via a public switched telephone network (PSTN), such that the PDA is operable in a hands-free mode by the user.

2. The system according to claim 1, wherein the microphone is a part of the housing.

3. The system according to claim 1, wherein the microphone is located remote from the housing and wirelessly connected to the VRM.

4. The system according to claim 1, further comprising a speaker connected to the VRM, wherein:
the PDA is configured to wirelessly receive a text message from the PSTN and transmit the message to the housing transceiver;
the housing transceiver is configured transmit the text message to the TTM; and
the TTM is configured to convert the text message into an auditory message which is broadcast to the user via the speaker.

5. The system according to claim 4, wherein the speaker is a part of the housing.

6. The system according to claim 4, wherein the speaker is located remote from the housing and wirelessly connected to the VRM.

7. The system according to claim 2, further comprising a cradle configured to receive the PDA, the cradle including an input/output (I/O) interface configured to control the PDA, and wherein the VRM is configured to convert verbal commands into digital commands that are transmitted to the I/O interface to control the PDA operation.

8. The system according to claim 1, further comprising a memory configured for storing telephonic communication information on at least one recipient.

9. The system according to claim 8, wherein the memory is configured to respond to at least one command verbally stated by the user and converted into at least one digital command by the VRM.

10. The system according to claim 1, wherein the housing is configured for mounting on a steering wheel of an automobile.

11. The system according to claim 1, wherein the housing includes at least one control switch that signals at least one signal of readiness of the user to transmit an auditory message.

12. A personal digital assistant (PDA) system, comprising:
a housing including:
a housing transceiver configured to wirelessly receive a text message from a PDA;
a text to speech module (TTM) connected to the housing transceiver and configured to convert a text into an auditory message;
a voice recognition module (VRM) connected to the housing transceiver and configured to convert auditory message into a text message; and
a speaker connected to the VRM and configured to receive and transmit the auditory message to the user; and
a PDA located a distance from the housing, the PDA being configured to wirelessly receive a text message from via a public switched telephone network (PSTN) and to transmit the text message to the housing transceiver, such that the PDA is operable in a hands-free mode by the user.

13. The system according to claim 12, wherein the speaker is located remote from the housing and wirelessly connected to the VRM.

14. The system according to claim 12, further comprising a microphone connected to the VRM, wherein:
the VRM is configured to convert an auditory message into a text message which is broadcast to the PDA;
the PDA is configured to wirelessly receive the text message and transmit the message to a PSTN; and
the housing transceiver is configured transmit the text message to the TTM.

15. The system according to claim 14, wherein the speaker is a part of the housing.

16. The system according to claim 12, further comprising a cradle configured to receive the PDA, the cradle including an input/output (I/O) interface configured to control the PDA and the VRM, which is configured to convert verbal commands into digital commands that are transmitted to the I/O interface to control the PDA operation.

17. The system according to claim 16, wherein the housing is configured for mounting on a steering wheel of an automobile.

18. The system according to claim 12, wherein the housing includes at least one control switch that signals at least one signal of readiness of the user to transmit an auditory message.
